(19) United States
(12) Patent Application Publication
(10) Pub. No.: US 2016/0273709 A1
(43) Pub. Date: Sep. 22, 2016

(54) SUPPORT ASSEMBLY

(71) Applicant: NLI INNOVATION AS, Vear (NO)

(72) Inventors: Andreas OLSSON, Tonsberg (NO); Anstein SØRENSEN, Solbergmoen (NO)

(21) Appl. No.: 14/442,344

(22) PCT Filed: Nov. 13, 2013
(86) PCT No.: PCT/EP2013/073701

§ 371 Date: May 12, 2015

Related U.S. Application Data
(60) Provisional application No. 61/725,516, filed on Nov. 13, 2012.

(30) Foreign Application Priority Data
Nov. 13, 2012 (NO) 20121338
Nov. 13, 2012 (NO) 20121344

(51) Int. Cl. F17C 1/02; B63B 25/16; F17C 1/12; G01M 3/00; F17C 1/00; F17C 13/00

(52) U.S. Cl. CPC F17C 1/02; F17C 1/002; F17C 13/001; F17C 1/12; G01M 3/002; B63B 25/16; F17C 2203/011; F17C 2203/0333; F17C 2205/0302; F17C 2221/033; F17C 2250/0439; F17C 2260/01; F17C 2270/0105

(57) ABSTRACT

The present disclosure relates to a support assembly (10) for a self-containing cryogenic tank (12). The support assembly (10) comprises a first thermally insulating layer (14) and an impermeable layer (16) located at least partially above the first thermally insulating layer (14). The impermeable layer (16) is adapted to form a drip tray (18) for the cryogenic tank (12). According to the present disclosure, the support assembly further comprises a second thermally insulating layer (20) located at least partially above the impermeable layer (16), the second thermally insulating layer (20) is adapted to support the cryogenic tank (12).

### TECHNICAL FIELD

The present disclosure relates to a support assembly for a self-containing cryogenic tank. Moreover, the present disclosure relates to a containment assembly for a self-containing cryogenic tank. Furthermore, the present disclosure relates to a vessel. Additionally, the present invention relates to a method for evaluating the tightness of a drip tray of a support assembly.

### BACKGROUND

A cryogenic tank is a tank that is adapted to contain a cryogenic fluid, i.e. a relatively cold fluid such as liquefied natural gas (LNG) or the like. The cryogenic tank may for instance be integrated in an enclosing structure, such as the hull of a ship, or it may be a self-containing tank.

A self-containing tank may preferably be provided in a structure adapted to accommodate the tank. Purely by way of example, a self-containing tank may be provided within a ship or on a deck of a ship. However, a self-containing tank may also be provided in other types of structures, such as a building or the like.

Preferably, a self-containing cryogenic tank is provided on a support assembly. FR 2659619 discloses an example of ship that is provided with a support assembly for a self-containing cryogenic tank. The '619 support assembly comprises a drip tray adapted to be located beneath the cryogenic tank. Moreover, '619 discloses that an insulating layer is placed between the drip tray and an inner portion of the ship's hull.

Furthermore, '619 teaches that the tank is attached to the ship by means of an attachment arrangement that comprises a plurality of upper steel protrusions each one of which extending downwards from the bottom of the self-containing cryogenic tank. Each one of the upper steel protrusion is adapted to rest on a corresponding lower steel protrusion extending from the inner portion of the ship's hull.

Although the above discussed attachment means may provide appropriate attachment capabilities as such, there are problems associated with the '619 support assembly. For instance, there is a risk that a thermal bridge could occur between the self-containing cryogenic tank and the ship.

### SUMMARY

One object of the disclosure is to reduce or ameliorate at least one of the disadvantages of the prior art systems and/or methods, or to provide a useful alternative.

This object is achieved by a support assembly according to claim 1.

As such, the present disclosure relates to a support assembly for a self-containing cryogenic tank. The support assembly comprises a first thermally insulating layer and an impermeable layer located at least partially above the first thermally insulating layer. The impermeable layer is adapted to form a drip tray for the cryogenic tank.

According to the present disclosure, the support assembly further comprises a second thermally insulating layer located at least partially above the impermeable layer, the second thermally insulating layer being adapted to support the cryogenic tank.

By virtue of the presence of the second thermally insulating layer, the risk of obtaining a thermal bridge between the self-containing cryogenic tank and the structure beneath the first thermally insulating layer is reduced. Moreover, the support assembly according to claim 1 could possibly also be easier to install and more robust than a prior art support assembly.

As used herein, the expression “thermally insulating layer” relates to a layer that has a relatively low coefficient of thermal transmittance, i.e. U-value. Purely by way of example, at least one, though preferably both, of the first thermally insulating layer and the second thermally insulating layer has an average U-value that is less than 10 W/m²K, preferably less than 4 W/m²K, more preferred less than 1 W/m²K.

As used herein, the expression “cryogenic tank” relates to a tank that is adapted to contain a cryogenic liquid, i.e. a liquid that has a low temperature. Purely by way of example, the liquid may have a temperature of −30° C. or less.

Moreover, as used herein, the expression “self-containing” encompasses any tank that does not have to be integrated with any additional enclosing structure in order to be adapted to contain a fluid. Purely by way of example, a self-containing tank within the above meaning may be adapted to be moved in relation to the structure in which it is adapted to be located. A self-containing tank may also be referred to as a self-supporting tank.

Optionally, the second thermally insulating layer is adapted to support at least 50%, preferably at least 70%, more preferred all, of the weight of the cryogenic tank. Thus, the second support layer is optionally adapted to carry a large portion of the weight of the tank. Preferably, the second thermally insulating layer is adapted to support at least 50%, preferably at least 70%, more preferred all, of the weight of the full cryogenic tank, i.e. when containing the cryogenic liquid.

Optionally, the drip tray is sized and configured such that, when the support assembly supports the cryogenic tank, a vertical projection of the circumference of a bottom of the self-containing cryogenic tank down to the drip tray is accommodated within the circumference of the drip tray.

As such, the drip tray may optionally have a size and position such that it is adapted to collect a leak from at least the bottom of the tank irrespective of the position of the leakage in the bottom.

Optionally, the first thermally insulating layer and/or the second thermally insulating layer comprises a plurality of thermally insulating panels that are arranged side-by-side. Purely by way of example, a thermally insulating panel may have a U-value that is less than 5 W/m²K, preferably less than 0.5 W/m²K, more preferred less than 0.1 W/m²K.

By the provision of thermally insulating panels, the transfer of relative motions between the cryogenic tank and the body onto which the support assembly may be resting could be reduced. For instance, if the cryogenic tank is located in or on a ship, the provision of the thermally insulating panels implies that e.g. deflections of the ship's hull are at least not fully transferred to the cryogenic tank. This in turn implies that the cryogenic tank may be subjected to moderate loads even when the ship hosting the cryogenic tank is deflected.

Optionally, the support assembly further comprises spacer means adapted to provide a space between at least two of the thermally insulating panels.

Optionally, the spacer means comprises a wood panel, preferably a plywood panel.

Optionally, at least one of the thermally insulating panels comprises a glass fibre reinforced polyurethane foam.

Optionally, the impermeable layer comprises a SUS membrane, preferably a stainless steel membrane. As used herein, the abbreviation “SUS” means Steel Use Stainless.

Optionally, the support assembly further comprises a frame adapted to at least partially accommodate the first thermally insulating layer, the second thermally insulating layer and the impermeable layer.

Optionally, the support assembly further comprises load distributing means, adapted to be located between the second thermally insulating layer and the cryogenic tank.

The load distributing means may be adapted to distribute loads from the cryogenic tank to the second thermally insulating layer. As such, any local loads that may possibly be imparted on the load distributing means from the cryogenic tank may be distributed to a larger area of the second thermally insulating layer. Preferably, the load distributing means may also have a relatively low friction coefficient in order to allow a displacement of at least a portion of the cryogenic tank in relation to e.g. the second thermally insulating layer.

Optionally, the load distributing means comprises a metal panel, preferably a plurality of metal panels.

Optionally, the support assembly further comprises a leak drain conduit assembly at least partially extending through the impermeable layer. As such, should a leakage occur in the tank, the fluid thus leaked may firstly enter the drip tray and thereafter be guided from the drip tray through the leak drain conduit assembly.

Optionally, the support assembly further comprises a tray leakage test assembly comprising a temperature sensor located outside the impermeable layer such that at least a portion of the first thermally insulating layer is located between the sensor and the impermeable layer. The tray leakage test assembly may enable that the tightness of the drip tray of the support assembly may be evaluated, e.g. occasionally and/or on a regular basis.

Optionally, the tray leakage test assembly comprises a plurality of temperature sensors each one of which being located outside the impermeable layer such that at least a portion of the first thermally insulating layer is located between the sensor and the impermeable layer.

Optionally, the support assembly further comprises an attachment means adapted to be engaged with a portion of the cryogenic tank to thereby limit a displacement of the cryogenic tank, relative to the support assembly, in at least one direction.

Optionally, the attachment means comprises a cavity adapted to receive a tank protrusion of the cryogenic tank.

Optionally, the attachment means is configured such that when it receives the tank protrusion, a gap is formed, in at least one direction of a vertical and horizontal direction, between the tank protrusion and the attachment means.

Optionally, the support assembly comprises a foundation for the attachment means. The foundation comprises a first foundation portion, located beneath the impermeable layer, and a second foundation portion, located above the impermeable layer.

Optionally, the foundation is located at least partially within the circumference of the drip tray. By virtue of the provision of the foundation within the circumference of the drip tray, the risk of obtaining a thermal bridge from the self-containing cryogenic tank to a structure outside the support assembly may be reduced.

Optionally, the first foundation portion is attached to the second foundation portion via the impermeable layer, preferably by a bolt joint.

Optionally, the first foundation portion is attached to the frame, preferably by a bolt joint.

Optionally, the first foundation portion and/or the second foundation portion is made of wood, preferably hard wood. Wood, preferably hard wood, may have an appropriate strength, but also an appropriate thermal insulating capacity in order to be a suitable material for the first and/or second foundation portion.

A second aspect of the present disclosure relates to a containment assembly for a self-containing cryogenic tank. The containment assembly comprises a support assembly according to the first aspect of the present disclosure and a tank cover. The tank cover is adapted to be connected to the support assembly to thereby define a closed volume adapted to accommodate the cryogenic tank.

Optionally, the assembly further comprises sealing means adapted to provide a seal between the support assembly and the tank cover.

Optionally, the containment assembly further comprises a tank leakage test assembly adapted to detect a leakage from the tank.

Optionally, the tank leakage test assembly comprises a gas detector.

Optionally, the containment assembly comprises the tank leakage test assembly in addition to the tray leakage test assembly.

A third aspect of the present disclosure relates to a tank assembly comprising a cryogenic tank and a support assembly according to the first aspect of the present disclosure and/or a containment assembly according to the second aspect of the present disclosure.

A fourth aspect of the present disclosure relates to a vessel comprising a support assembly according to the first aspect of the present disclosure and/or a containment assembly according to the second aspect of the present disclosure and/or a tank assembly according to the third aspect of the present disclosure.

Optionally, the cryogenic tank is located in a vessel portion of the vessel. The cryogenic tank is configured such that a deflection of the vessel portion results in a corresponding deflection of the cryogenic tank.

A fifth aspect of the present disclosure relates to a method for evaluating the tightness of a drip tray of a support assembly for a self-containing cryogenic tank. The support assembly comprises a first thermally insulating layer and an impermeable layer located at least partially above the first thermally insulating layer. The support assembly comprises a temperature sensor located outside the impermeable layer such that at least a portion of the first thermally insulating layer is located between the sensor and the impermeable layer. The impermeable layer at least partially forms the drip tray. The method comprises:
introducing a fluid into the drip tray, the fluid having a temperature that is different from the temperature of the environment ambient of the support assembly, and
determining a value indicative of the temperature in the vicinity of the temperature sensor.

Optionally, the support assembly comprises a plurality of temperature sensors each one of which being located outside the impermeable layer such that at least a portion of the first thermally insulating layer is located between the sensor and the impermeable layer. Moreover, the method optionally comprises determining a value indicative of the temperature in the vicinity of each one of the temperature sensors.

Optionally, the fluid is introduced from a fluid source that is separate from the cryogenic tank.

Optionally, the fluid has a temperature which is lower than the temperature of the ambient environment, preferably the fluid is liquid nitrogen.

Optionally, the value indicative of the temperature comprises a temperature in the vicinity of the temperature sensor, or in the vicinity of each one of the plurality of temperature sensors if the support assembly comprises a plurality of sensors. The method further comprises:
comparing the temperature to a predetermined temperature range in order to determine whether or not the tightness of the drip tray is impaired.

Optionally, the value indicative of the temperature comprises a temperature change rate in the vicinity of the temperature sensor, or in the vicinity of each one of the plurality of temperature sensors if the support assembly comprises a plurality of sensors.

Optionally, the method further comprises:
comparing the temperature change rate to a predetermined temperature change rate range in order to determine whether or not the tightness of the drip tray is impaired.

### BRIEF DESCRIPTION OF THE DRAWINGS

With reference to the appended drawings, below follows a more detailed description of embodiments of the invention cited as examples.

In the drawings:

FIG. 1 illustrates an embodiment of a support assembly for a self-containing cryogenic tank;

FIG. 2A is a cross-sectional view of a portion of the FIG. 1 embodiment of the support assembly;

FIG. 2B illustrates a portion of an embodiment of a support assembly;

FIG. 2C is a top view and a side view of an implementation of a load distribution plate;

FIG. 3 is a top view of a portion of the FIG. 1 embodiment of the support assembly;

FIG. 4 is a perspective view of another embodiment of a support assembly;

FIG. 5 is a perspective view of a self-containing cryogenic tank;

FIG. 6 is a perspective view of an arrangement of attachment means;

FIG. 7 is a side view of an implementation of an attachment means;

FIG. 8 is a side view of an implementation of another attachment means;

FIG. 9 is a cross-sectional view of a portion of an embodiment of a support assembly;

FIG. 10 is a side view of an embodiment of a containment assembly;

FIG. 11 is a side view of an embodiment of a containment assembly further illustrating an implementation of a tank leakage test assembly;

FIG. 12 illustrates schematic side views of a vessel comprising a tank assembly, and

FIG. 13 illustrates a side view and a top view of an implementation of a tray leakage test assembly.

It should be noted that the appended drawings are not necessarily drawn to scale and that the dimensions of some features of the present invention may have been exaggerated for the sake of clarity.

### DETAILED DESCRIPTION OF PREFERRED EMBODIMENTS

The invention will, in the following, be exemplified by embodiments. It is to be understood, however, that the embodiments are included in order to explain principles of the invention and not to limit the scope of the invention defined by the appended claims.

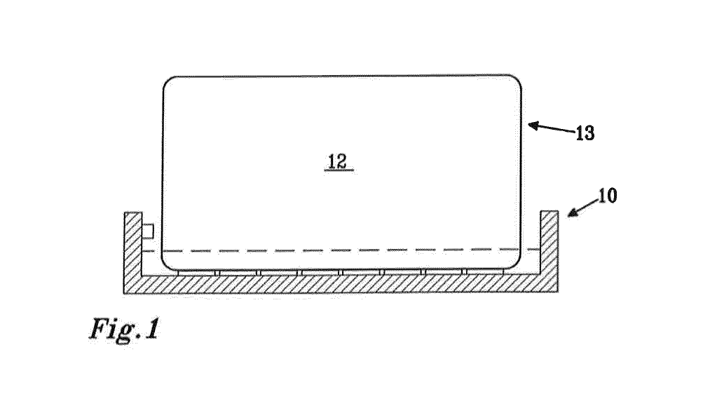

FIG. 1 illustrates a support assembly 10 for a self-containing cryogenic tank 12. The self-containing cryogenic tank 12 is adapted to contain a cryogenic fluid, e.g. liquefied natural gas (hereinafter referred to as LNG), liquefied carbon dioxide or liquefied propane gas (hereinafter referred to as LPG). To this end, the self-containing cryogenic tank 12 preferably comprises a first sealing barrier 13 enclosing a closed volume adapted to receive the cryogenic fluid. Moreover, the self-containing cryogenic tank 12 may preferably comprise reinforcement means (not shown in FIG. 1) in order to reinforce the first sealing barrier 13. Purely by way of example, such reinforcement means may comprise one or more girders and/or stringers (not shown in FIG. 1).

As a non-limiting example, the volume of the self-containing cryogenic tank 12 may be in the range of 100-2000 m³, preferably within the range of 500-1500 m³.

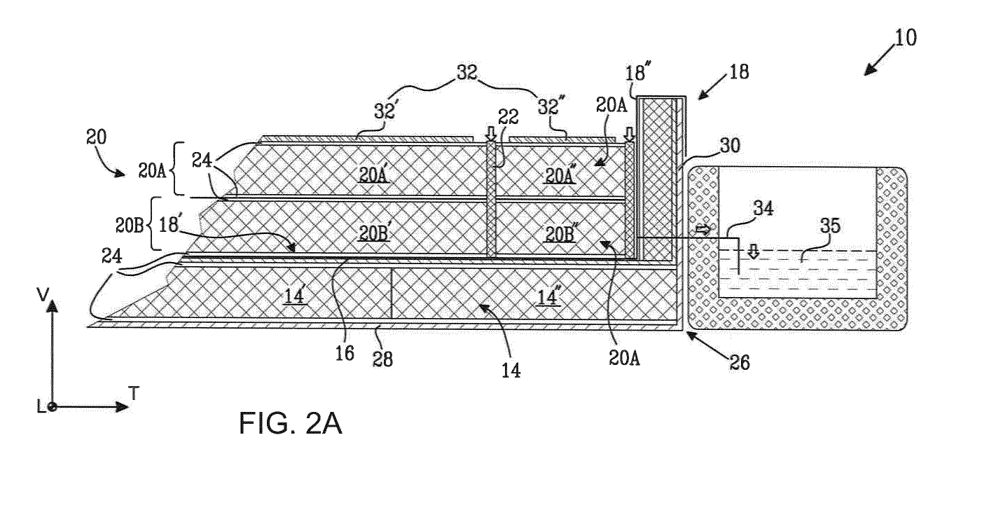

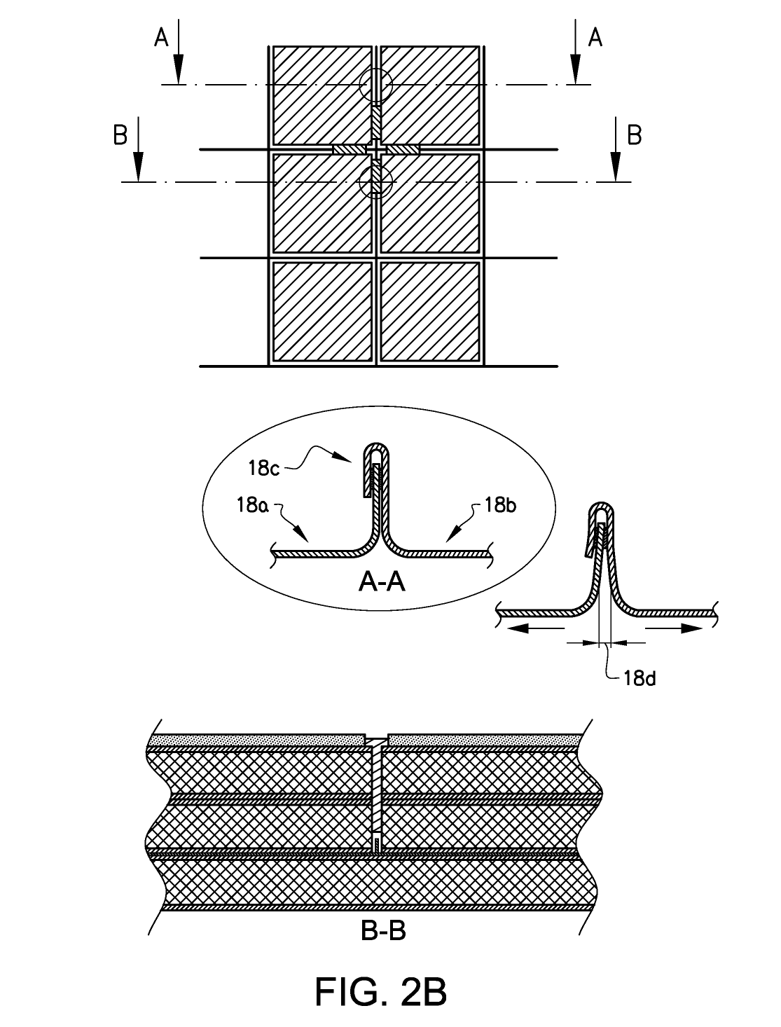

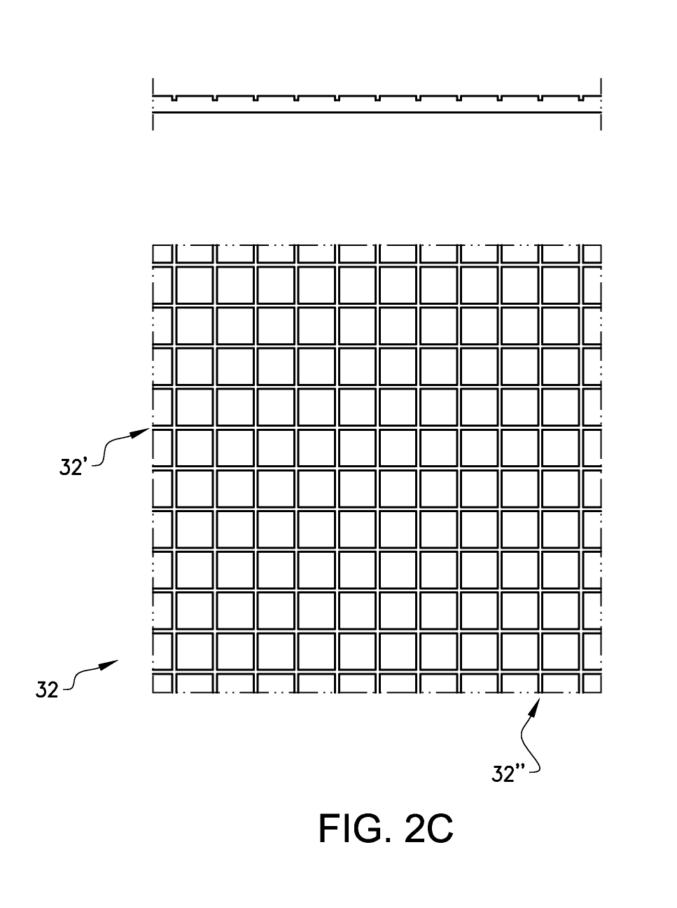

FIG. 2A illustrates a cross-section of a portion of the FIG. 1 support assembly 10. As may be gleaned from FIG. 2A, the support assembly 10 comprises a first thermally insulating layer 14 and an impermeable layer 16 located at least partially above the first thermally insulating layer 14.

Moreover, FIG. 2A illustrates that the support assembly 10 extends in a longitudinal direction L, a transversal direction T and a vertical direction V. As such, the above discussed feature that the impermeable layer 16 is located at least partially above the first thermally insulating layer 14 means that in at least a specific location, in the longitudinal direction L and the transversal direction T, the impermeable layer 16 is located at a higher level, in the vertical direction V, than the first thermally insulating layer 14.

Moreover, FIG. 2A illustrates that the impermeable layer 16 is adapted to form a drip tray 18 for the cryogenic tank (the tank is not shown in FIG. 2A). As such, should a fluid leakage occur from the tank, the fluid leaked may be collected by the drip tray 18.

Preferably, the drip tray 18 comprises a drip tray base portion 18′ and a drip tray rim portion 18″. The drip tray rim portion 18″ has preferably an extension which is at least partially in parallel with the vertical direction V. The drip tray base portion 18′ and the drip tray rim portion 18″ may be connected to one another so as form a tray that can collect and/or contain a fluid. It should be noted that the drip tray 18 could preferably be an open tray such as the implementation of the drip tray 18 illustrated in FIG. 2A. Purely by way of example, the volume defined by the drip tray 18, e.g. the drip tray base portion 18′ and the drip tray rim portion 18″, may be within the range of 2-50%, preferably 10-30%, of the volume of the self-containing cryogenic tank 12.

As a non-limiting example, the drip tray 18 may be adapted to store leaked fluid, i.e. any fluid that may leak from the self-containing cryogenic tank 12, for a predefined time period, such as 15 days or more, without damaging any structure that surrounds the support assembly 10.

To this end, though again only as a non-limiting example, at least one of the first thermally insulating layer 14 and the second thermally insulating layer 20 may have thermally insulating properties that allows leaked fluid to be stored in the drip tray 18 for a predetermined time period without adversely affecting the structure surrounding the support assembly 10.

As a non-limiting example, the leaked fluid that may be at least temporarily contained in the drip tray 18 may be evaporated and ventilated by purging the drip tray 18 with a gas, such as nitrogen gas.

Purely by way of example, the second thermally insulating layer 20, which will be discussed in more detail hereinbelow, may have an absorbing capacity, i.e. the second thermally insulating layer 20 may be adapted to absorb at least a portion of the amount of fluid that may leak from the self-containing cryogenic tank 12. The absorbing capacity may for instance be obtained by providing spaces between panels of the second thermally insulating layer 20.

Only a portion of the impermeable layer 16 may form the drip tray 18, e.g. the drip tray base portion 18′ and the drip tray rim portion 18″ in the FIG. 2A implementation. As such, in embodiments of the support assembly 10, the impermeable layer 16 could extend beyond the drip tray 18. However, in other implementations of the impermeable layer 16, the drip tray 18 may include the complete impermeable layer 16.

Furthermore, as a non-limiting example, the impermeable layer 16 may comprise a SUS membrane. Purely by way of example, the impermeable layer 16 may have a thickness within the range of 1-5 mm, preferably within the range of 2-3 mm.

The impermeable layer 16 layer may comprise a plurality of panels that are attached to one another, e.g. by means of weld joints. Optionally, the impermeable layer 16 may include one single panel. Purely by way of example, at least a portion of the impermeable layer 16 may be bent so as to assume the shape of the drip tray 18.

In the FIG. 2A embodiment, the drip tray 18 is sized and configured such that, when the support assembly supports the cryogenic tank, a vertical projection of the circumference of a bottom of the self-containing cryogenic tank down to the drip tray is accommodated within the circumference of the drip tray 18.

FIG. 2A further illustrates that the support assembly also comprises a second thermally insulating layer 20 located at least partially above the impermeable layer 16. The second thermally insulating layer 20 is adapted to support the cryogenic tank.

It is envisaged that embodiments of the support assembly 10 may comprise a second layer 20 which is not, or at least not primarily, thermally insulating. In such an embodiment of a support assembly 10, the second layer 20 may instead be designed with a focus on providing a tank support function.

Moreover, FIG. 2A illustrates an embodiment of the support assembly 10 wherein the first thermally insulating layer 14 and/or the second thermally insulating layer 20 comprises a plurality of thermally insulating panels that are arranged side-by-side. Specifically, FIG. 2A illustrates an embodiment wherein the first thermally insulating layer 14 comprises a plurality of thermally insulating first panels 14′, 14″ arranged side-by-side and wherein the second thermally insulating layer 20 comprises two sub-layers 20A, 20B. The first sub-layer 20A comprises a plurality of thermally insulating first sub-layer panels 20A′, 20A″ arranged side-by-side and the second sub-layer 20B comprises a plurality of thermally insulating second sub-layer panels 20B′, 20B″ arranged side-by-side.

Purely by way of example, at least two of the thermally first or second insulating panels 14′, 14″, 20A′, 20A″, 20B′, 20B″ may be arranged such that a gap is obtained between the two panels. As a non-limiting example, the gap main be a void such that air is present in the gap. FIG. 2A further illustrates another non-limiting example wherein the support assembly 10 may preferably comprise spacer means 22 adapted to provide a space between at least two of the thermally insulating panels 20A′, 20A″, 20B′, 20B″. Moreover, the spacer means 22 may preferably also be arranged to assist in keeping the thermally insulating panels 20A′, 20A″, 20B′, 20B″ in place during use.

Purely by way of example, the spacer means 22 comprises a wood panel, preferably a plywood panel. Moreover, FIG. 2A illustrates a preferred implementation of a spacer means 22, wherein the spacer means 22 has an extension in the vertical direction V.

Preferably, at least one, but preferably the majority, of the thermally insulating panels comprises a glass fibre reinforced polyurethane foam. In the embodiment illustrated in FIG. 2A, each one of the thermally insulating panels 14′, 14″, 20A′, 20A″, 20B′, 20B″ comprises a glass fibre reinforced polyurethane foam.

Irrespective of which material that is used, as a non-limiting example, a thermally insulating panel 14′, 14″, 20A′, 20A″, 20B′, 20B″, when arranged in the support assembly 10, may preferably have a compressive strength in the vertical direction V of at least 2 MPa, preferably at least 5 MPa, more preferred at least 7 MPa. Moreover, as a non-limiting example, a thermally insulating panel 14′, 14″, 20A′, 20A″, 20B′, 20B″ may have a compressive modulus in the vertical direction V of at least 100 MPa, preferably at least 140 MPa, more preferred at least 160 MPa. Furthermore, although purely by way of example, the thermal conductivity coefficient of the material of a thermally insulating panel may preferably be less than 1 W/mK, preferably less than 0.5 W/mK, more preferred less than 0.1 W/mK. A thermally insulating panel may be referred to as a slab.

As a non-limiting example, the thermal insulation around a tank 12, e.g. the insulation of the walls and/or the roof of an insulating structure surrounding the tank 12, may comprise, or alternatively consist of, one or more of the following materials: expanded polystyrene foam and polyurethane foam. Non-limiting examples for each one of the two different materials are presented in Tables 1 to 2 hereinbelow.

TABLE 1
Example material data for expanded polystyrene (EPS) foam

| PROPERTIES EPS | | | | TEST |
|---|---|---|---|---|
| FOAM | UNIT | 25° C. | −163° C. | METHOD |
| Density | kg/m³ | 25 | — | DIN 53420/ |
| | | | | ISO 845 |
| Tensile strength | kPa | 235 | 340 | ISO 1926-1979 |
| Compressive strength | kPa | 140 | 175 | ISO 844-1978 |
| 10% compression | | | | |
| Coefficient of thermal | mm/° K | 5.8 × 10⁻⁵ | 5.8 × 10⁻⁵ | ISO 4897-85 |
| contraction | | | | |
| Thermal conductivity, | mm/° K | 0.034 | 0.034 | ASTM C 518 |
| aged 10 years | | | | |
| Flammability (passed) | | | | DIN 4102, |
| | | | | Part 1, B2 |

TABLE 2
Example material data for polyurethane (PU) foam

| PROPERTIES PU | | | | TEST |
|---|---|---|---|---|
| FOAM | UNIT | 25° C. | −163° C. | METHOD |
| Density | kg/m³ | ~40 | — | DIN 53420/ |
| | | | | ISO 845 |
| Tensile strength | kPa | 235 | 340 | ISO 1926-1979 |
| Compressive strength | kPa | 140 | 175 | ISO 844-1978 |
| 10% compression | | | | |
| Coefficient of thermal | mm/° K | 5.9 × 10⁻⁵ | 5.9 × 10⁻⁵ | ISO 4897-85 |
| contraction | | | | |
| Thermal conductivity, | mm/° K | 0.023 | 0.012 | ASTM C 518 |
| aged 10 years | | | | |
| Flammability (passed) | | | | DIN 4102, |
| | | | | Part 1, B2 |

Moreover, as a non-limiting example, one or more of the thermally insulating panels may comprise, or alternatively consist of glass fiber reinforced polyurethane foam. Non-limiting examples for glass fiber reinforced polyurethane foam are presented in Table 3 hereinbelow. It is also envisaged that the glass fiber reinforced polyurethane foam may also, or instead, be used for thermal insulation of the walls and/or the roof surrounding a tank 12.

TABLE 3
Example material data for glass fiber reinforced
polyurethane (PU) foam

| PROPERTIES GFR | | | | TEST |
|---|---|---|---|---|
| PU FOAM | UNIT | 25° C. | −163° C. | METHOD |
| Density | kg/m³ | 300 | — | DIN 53420/ |
| | | | | ISO 845 |
| Tensile strength | kPa | 3480 | — | ISO 1926-1979 |
| Compressive strength | kPa | 7100 | — | ISO 844-1978 |
| 10% compression | | | | |
| Coefficient of thermal | mm/° K | ~1 × 10⁻⁵ | ~1 × 10⁻⁵ | ISO 4897-85 |
| contraction | | | | |
| Thermal conductivity, | mm/° K | 0.0484 | 0.012 | ASTM C 518 |
| aged 7 months | | | | |

Moreover, FIG. 2A illustrates that the support assembly 10 may preferably comprise intermediate panels 24 located above and/or beneath each one of the first and second thermally insulating layers 14, 20. Moreover, a layer that comprises a plurality of sub-layers, such as the second thermally insulating layer in the FIG. 2A embodiment, may comprise intermediate panels 24 above and/or beneath each one of the sub-layers 20a, 20B. Purely by way of example, the intermediate panel 24 may be a wood panel, preferably a plywood panel.

Additionally, the FIG. 2A embodiment of the support assembly 10 comprises a frame 26 adapted to at least partially accommodate the first thermally insulating layer 14, the second thermally insulating layer 20 and the impermeable layer 16. FIG. 2A illustrates a preferred implementation of the frame 26 which comprises a substantially horizontally extending frame base portion 28 and a frame rim portion 30 that extends in a direction that is at least partially parallel to the vertical direction V. As a non-limiting example, the frame rim portion 30 may extend in a substantially vertical direction V from the frame base portion 28.

FIG. 2A further illustrates that the first thermally insulating layer 14 may comprise a vertically extending portion, located adjacent to the frame rim portion 30. Moreover, FIG. 2A illustrates that the impermeable layer 16 may preferably be shaped such that is at least partially extends beyond the top of the frame rim portion 30.

Furthermore, FIG. 2A illustrates that the support assembly 10 may preferably comprise load distributing means 32, adapted to be located between the second thermally insulating layer 20 and the cryogenic tank. In FIG. 2A, the load distributing means comprises plurality of metal panels 32′, 32″. As a non-limiting example, the load distributing means may comprise a plurality of steel panels 32′, 32″.

The support assembly 10 preferably comprises a leak drain conduit assembly 34 at least partially extending through the impermeable layer 16. The support assembly may also comprise a leak drain collector means 35, such as a leak drain collector container, adapted to be in fluid communication with the leak drain conduit assembly 34. As such, should a tank leakage occur, tank leakage fluid could be collected by the drip tray 18 and thereafter conducted to the leak drain collector means 35 via the leak drain conduit assembly 34. The leaked fluid may for instance subsequently be guided to a temporary or permanent leak drain connector tank (not shown).

FIG. 2B illustrates a portion of another embodiment of a support assembly 10. In the FIG. 2B embodiment, the drip tray base portion 18′ comprises a plurality of metal panels 18a, 18b that are attached to one another via joints 18c, such as seam welded overlap joints. Purely by way of example, the joints 18c may be such that they allow a relative displacement between adjacent metal panels 18a, 18b. As a non-limiting example, the joints 18c may be such that they provide a gap 18d between adjacent metal panels 18a, 18b, should thermal shrinkage occur in the panels 18a, 18b.

As a non-limiting example, the size and position of the thermally insulating panels 20A′, 20A″, 20B′, 20B″ and the spacer means 22 may be selected such that the joints 18c are located between adjacent thermally insulating panels 20A′, 20A″, 20B′, 20B″.

FIG. 2C illustrates another implementation of the load distributing means 32 than what is illustrated in FIG. 2A. The FIG. 2C implementation of the load distribution means 32 comprises a panel which in turn comprises a plurality of grooves 32′, 32″ that are adapted to face the tank (not shown in FIG. 2C). Purely by way of example, and as is indicated in FIG. 2C, the grooves 32′, 32″ may comprise a first set of groves 32′ and a second set of grooves 32″. The first and second sets of grooves 32′, 32″ may extend in different directions and as a non-limiting example, the first and second sets of grooves 32′, 32″ may extend in perpendicular directions.

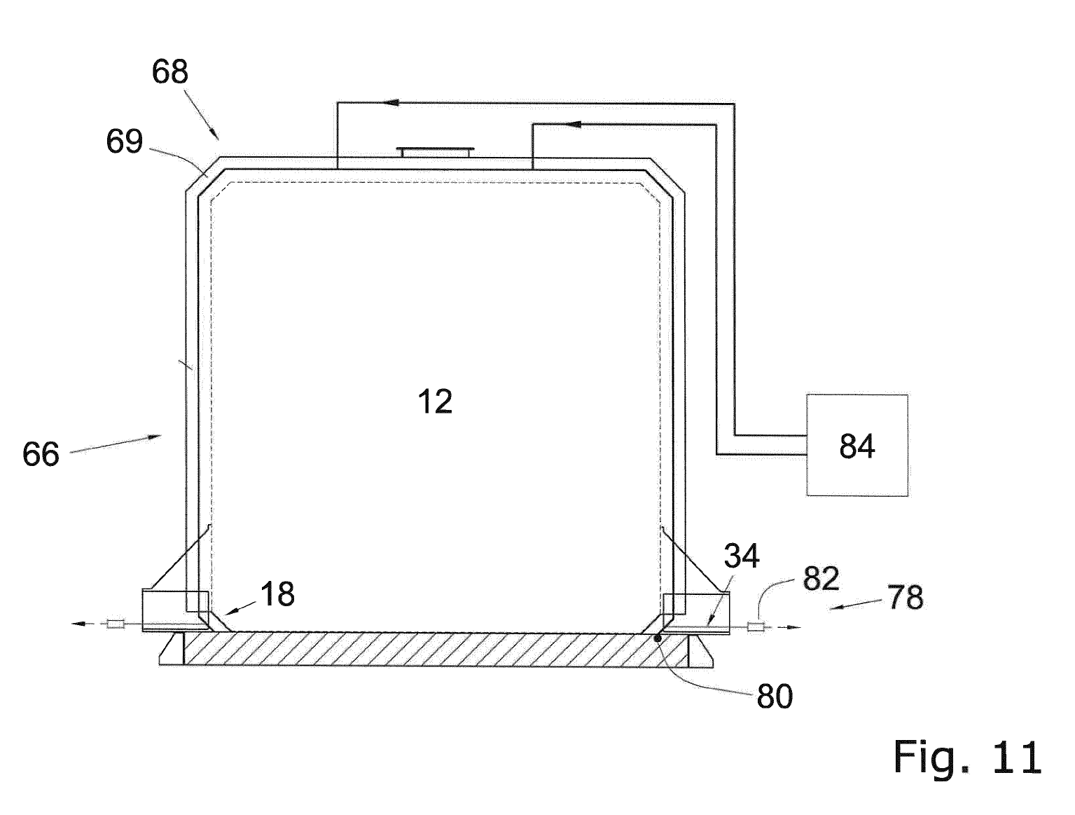

The grooves 32′, 32″ may have the advantage that fluid that may leak from the tank onto the load distribution means 32 will be guided towards the periphery thereof via the grooves. The leaked fluid may then communicate with leakage sensors (such sensors are presented hereinbelow with reference to FIG. 11) such as temperature sensors that could be placed close to the periphery of the load distribution means 32.

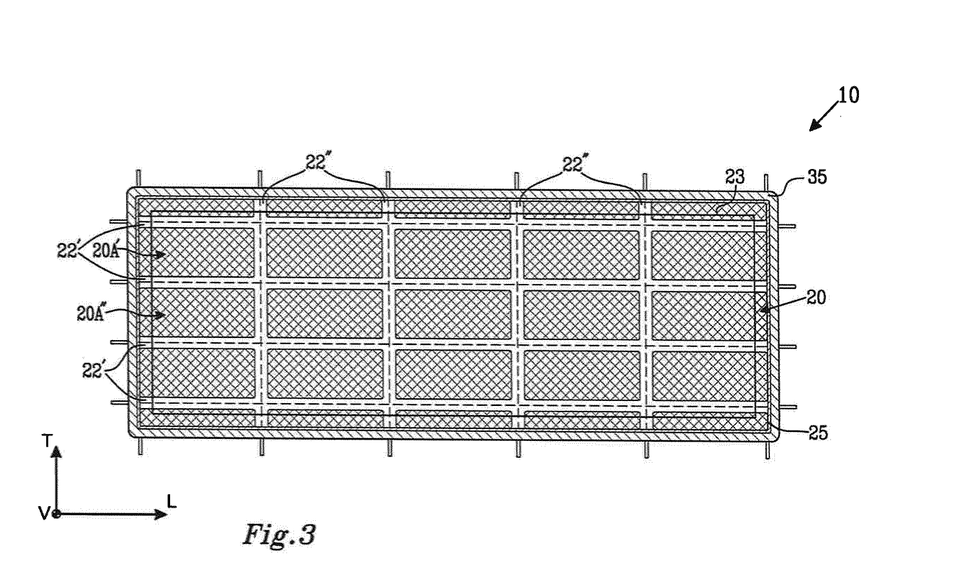

FIG. 3 illustrates a top view of the FIG. 2A embodiment of the support assembly 10. As may be gleaned from FIG. 3, the second thermally insulating layer 20 may comprise a plurality of thermally insulating panels 20A′, 20A″. Preferably, the thermally insulating panels 20A′, 20A″ may be separated from one another by longitudinally extending spacer means 22′ and/or transversally extending spacer means 22″. Preferably, the spacer means 22′, 22″ are of a thermally insulating material.

FIG. 3 further schematically illustrates the circumference 23 of the cryogenic tank adapted to be hosted by the support assembly 10 (the tank as such is not shown in FIG. 3). Moreover, FIG. 3 illustrates the circumference 25 of the drip tray 18.

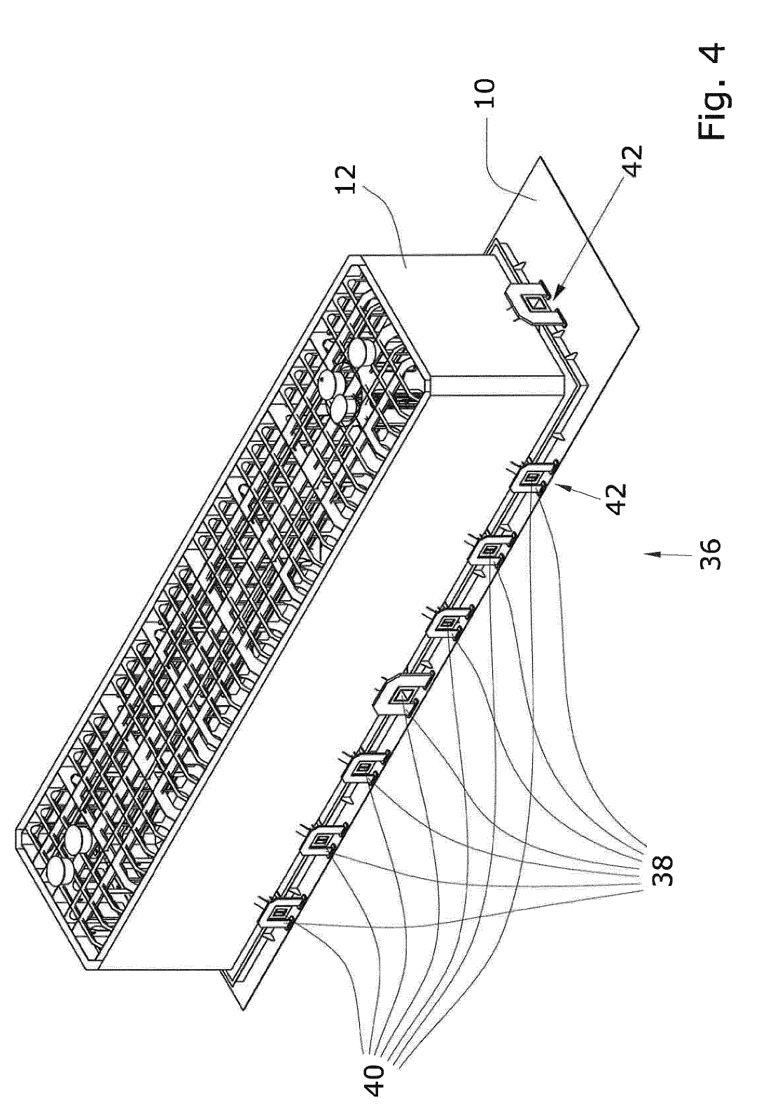

FIG. 4 illustrates an embodiment of the support assembly 10 that further comprises an attachment assembly 36. The attachment assembly 36 comprises attachment means 38 adapted to be engaged with a portion 40 of the cryogenic tank 12 to thereby limit a displacement of the cryogenic tank 12, relative to the support assembly 10, in at least one direction.

As may be gleaned from FIG. 4, at least one of the attachment means 38 preferably comprises a cavity 42 adapted to receive a tank protrusion 40 of the cryogenic tank.

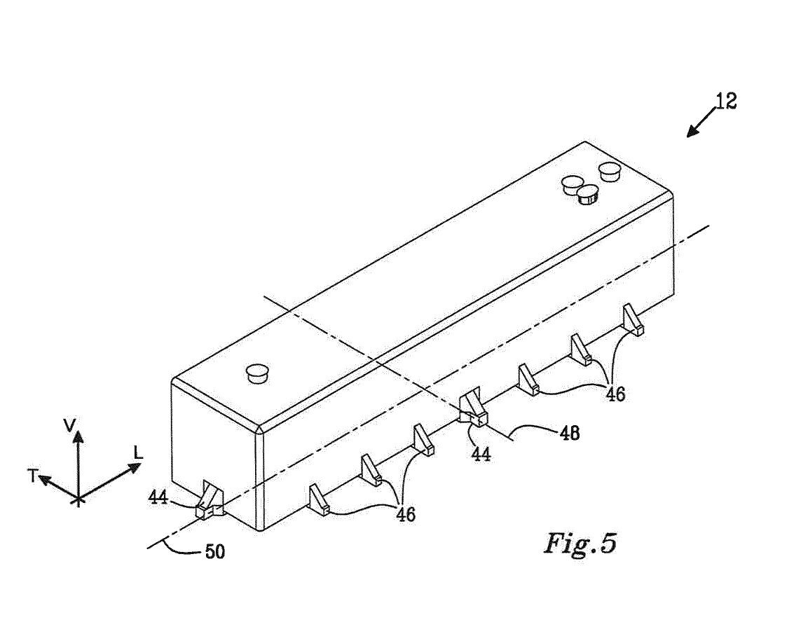

FIG. 5 illustrates a preferred implementation of a self-containing cryogenic tank 12 that comprises two types of protrusions, viz a first protrusion type 44 and a second protrusion type 46. The first protrusion type 44 may preferably be located at positions close to the longitudinal 48 or transversal 50 centre of the self-containing cryogenic tank 12. The second protrusion type 46 may be located at a distance, in the longitudinal and/or transversal direction, from the longitudinal 48 or transversal centre 50 of the self-containing cryogenic tank 12. As such, a second protrusion type 46 may preferably be located at a larger distance than the first protrusion type 44, in the longitudinal or transversal direction, from a longitudinal 48 or transversal 50 centre.

Purely by way of example, the first protrusion type 44 may have a horizontal strength that is larger than the horizontal strength of the second protrusion type 46.

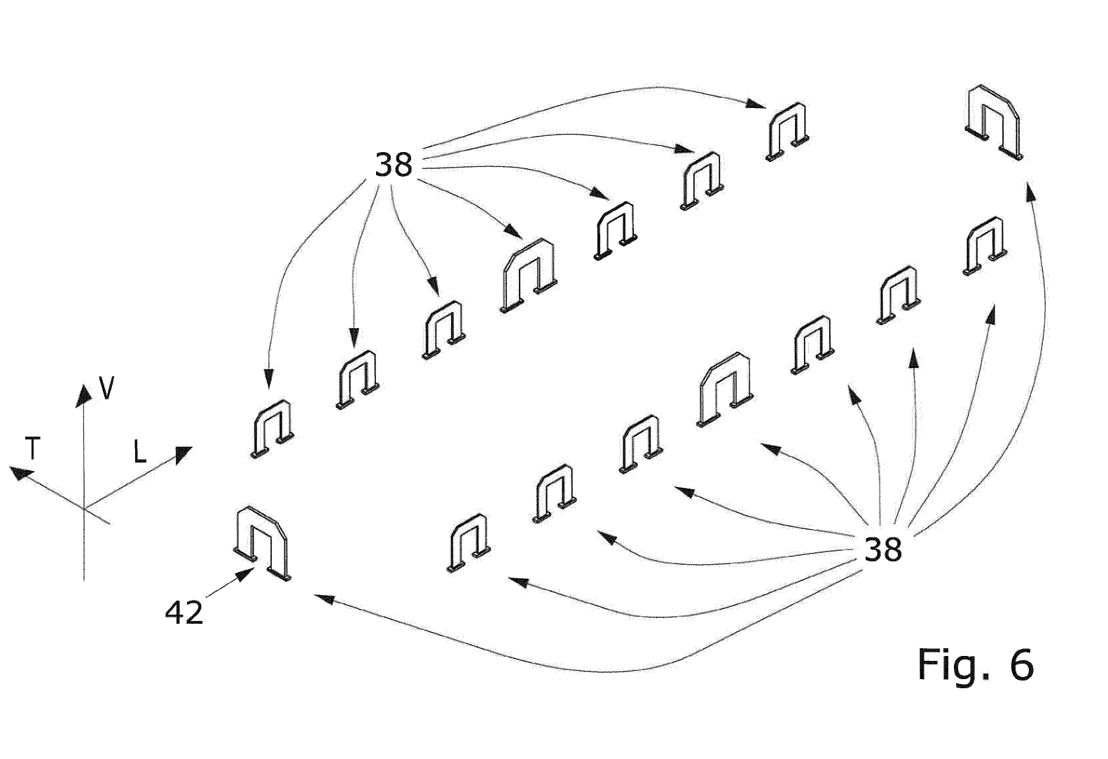

FIG. 6 illustrates a plurality of attachment means 38, which attachment means may also be referred to as stools, in a configuration adapted to receive the FIG. 5 self-containing cryogenic tank (not shown in FIG. 6). Purely by way of example, each one of the attachment means 38 may be made of a metal, such as steel. Moreover, FIG. 6 illustrates a preferred implementation of the attachment means 38 wherein each one of the attachment means comprises a panel, preferably a steel panel, which in turn comprises the above discussed cavity 42.

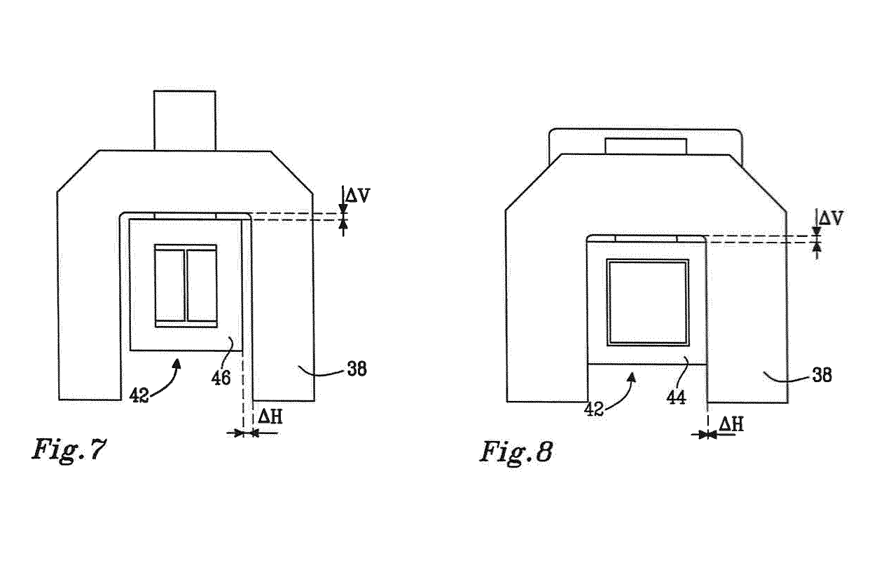

FIG. 7 illustrates one of the FIG. 6 attachment means 38 and the second protrusion type 46 of the self-containing cryogenic tank 12. As may be gleaned from FIG. 7, the attachment means 38 and/or the second protrusion type 46 is preferably configured such that when it receives the tank protrusion 46, a gap is formed, in at least one direction of a vertical and horizontal direction, between the tank protrusion 46 and the attachment means 38. In the FIG. 7 implementation, a non-zero vertical gap ΔV as well as a non-zero horizontal gap AH is formed between the second protrusion type 46 and the attachment means 38. In particular the non-zero horizontal gap AH discussed above implies that e.g. an expansion of the tank may be allowed. Such an expansion may for instance be a thermal expansion. Purely by way of example, the vertical gap ΔV in the FIG. 7 implementation may be greater than or equal to 15 mm, preferably greater than or equal to 30 mm. As another non-limiting example, the horizontal gap AH in the FIG. 6 implementation may be greater than or equal to 30 mm, preferably greater than or equal to 50 mm.

FIG. 8 illustrates one of the FIG. 6 attachment means 38 and the first protrusion type 44 of the self-containing cryogenic tank 12. FIG. 8 illustrates that, when the first protrusion type 44 of the tank 12 is at least partially received by the attachment means 38, a non-zero vertical gap ΔV is formed between the first protrusion type 44 and the attachment means 38. However, as compared to the FIG. 6 implementation, the horizontal gap AH between the first protrusion type 44 and the attachment means 38 is close to zero. As a non-limiting example, the horizontal gap AH in the FIG. 8 implementation may be equal to or less than 5 mm, preferably equal to or less than 2 mm. Purely by way of example, the vertical gap ΔV in the FIG. 8 implementation may be greater than or equal to 15 mm, preferably greater than or equal to 30 mm.

During e.g. a thermal expansion or a thermal compression, the longitudinal end portions of the tank (not shown in FIG. 7 of FIG. 8) may be displaced to a larger extent than a portion of the tank that is located close to the longitudinal centre of the tank. As such, the attachment means 38 and/or the second protrusion type 46 associated with a longitudinal end portion of the tank may, as a non-limiting example, have a larger horizontal gap ΔH than the attachment means 38 and/or the second protrusion type 46 associated with a portion of the tank that is associated with a position close to the longitudinal centre of the tank. Thus, the implementation of the attachment means 38 and the second protrusion type 46 presented hereinabove with reference to FIG. 7 may be associated with a longitudinal end portion of the tank whereas the implementation of the attachment means 38 and the second protrusion type 46 presented hereinabove with reference to FIG. 8 may be associated with a position close to the longitudinal centre of the tank.

The non-zero vertical gap ΔV in each one of the FIG. 7 and FIG. 8 implementations may be preferred in order to allow a relative vertical displacement between a tank and the structure accommodating the tank and support assembly 10. Purely by way of example, if the structure assembly 10 and the tank 12 are located in a ship (not shown), a vertical displacement between the ship and the tank may occur when the ship is deflected, e.g. when the ship is subjected to wave loads. Wave load induced deflections of a ship may be referred to as hogging and sagging.

As a non-limiting example, and as may be gleaned from e.g. FIG. 5, each one of the tank protrusions 40 may preferably have a height that is increasing towards the self-containing cryogenic tank 12 in order to reduce the relative displacement between the self-containing cryogenic tank 12 and the attachment means 38 in a direction parallel to the extension of the tank protrusion 40.

The attachment means 38 illustrated in FIG. 6-FIG. 8 hereinabove may be placed within the support assembly 10 or outside of the support assembly 10.

However, in preferred embodiments of the support assembly 10, at least some, though preferably all, of the attachment means 38 are located within the support assembly 10.

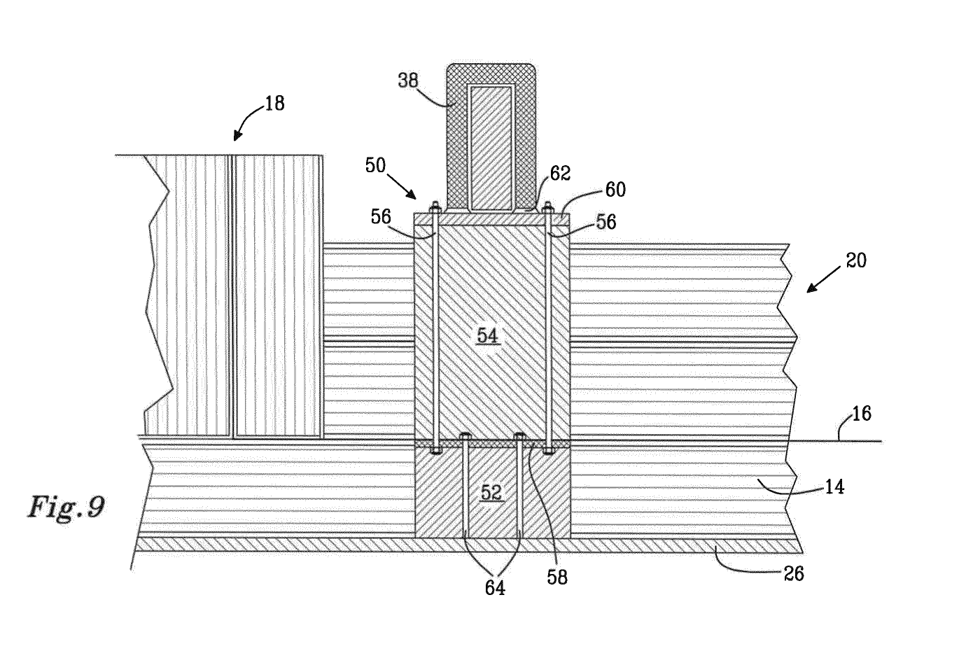

To this end, reference is made to FIG. 9 that illustrates a preferred embodiment of the support assembly 10 that comprises a foundation 50 for the attachment means 38. The foundation 50 is located at least partially within the circumference of the drip tray 18. In the FIG. 9 embodiment, the foundation 50 is located completely within the drip tray 18.

As may be gleaned from FIG. 9, the foundation 50 may preferably comprise a first foundation portion 52, located beneath the impermeable layer 16, and a second foundation portion 54, located above the impermeable layer 16. In the FIG. 9 implementation, the first and second foundation portions 52, 54 are located beneath/above a portion of the impermeable layer 16 that forms the drip tray 18. However, in other implementations, the first and second foundation portions 52, 54 may instead be associated with a portion of the impermeable layer 16 that is located outside the drip tray 18. As such, it should be noted that the presentation hereinbelow as regards various implementations of the foundation 50 is equally applicable to implementations of the foundation 50 that are adapted to be located at least partially outside the circumference of the drip tray 18.

The first and second foundation portions 52, 54 are preferably made of a thermally insulating material. Purely by way of example, at least one of the first and second foundation portions 52, 54 is made of wood, preferably hard wood.

The first foundation portion 52 may preferably be attached to the second foundation portion 54 via the impermeable layer 16. In the FIG. 8 implementation, the above attachment is achieved by a bolt joint 56 comprising a plurality of bolts.

The foundation 50 may preferably also comprise a first connection panel 58 adapted to be located between the first foundation portion 52 and the impermeable layer 16. Moreover, the foundation may preferably also comprise a second connection panel 60 adapted to be located between the second foundation portion 54 and the attachment means 38. Preferably, the attachment means 38 is attached to the second connection panel 60 by means of a joint, such as a weld joint 62.

The first and second connection panel 58, 60 are preferably made of a relatively strong material. Purely by way of example, at least one of the first and second connection panel 58, 60 is made of metal, preferably steel.

Moreover, FIG. 9 illustrates that the bolts of the bolt joint 56 may extend from the first connection panel 58 to the second connection panel 60 such that the bolts may provide a tension between the first and second connection panels 58, 60. In this way, the first and second foundation portions 52, 54 may be attached to one another without subjecting the impermeable layer 16 to undesirably large stresses. Moreover, the provision of the first and second connection panels 58, 60 implies a reduced risk of obtaining large local stresses in the first or second foundation portion 52, 54.

In embodiments of the support assembly 10 that comprises a frame 26, such as the FIG. 9 embodiment, the first foundation portion 52 may preferably be attached to the frame 26, preferably by a second bolt joint 64.

In order to further reduce the risk of obtaining a thermal bridge between the attachment means 38 and the frame 26, at least one of the first and second bolt joints 56, 64 may preferably comprise thermally insulating washers (not shown in FIG. 9).

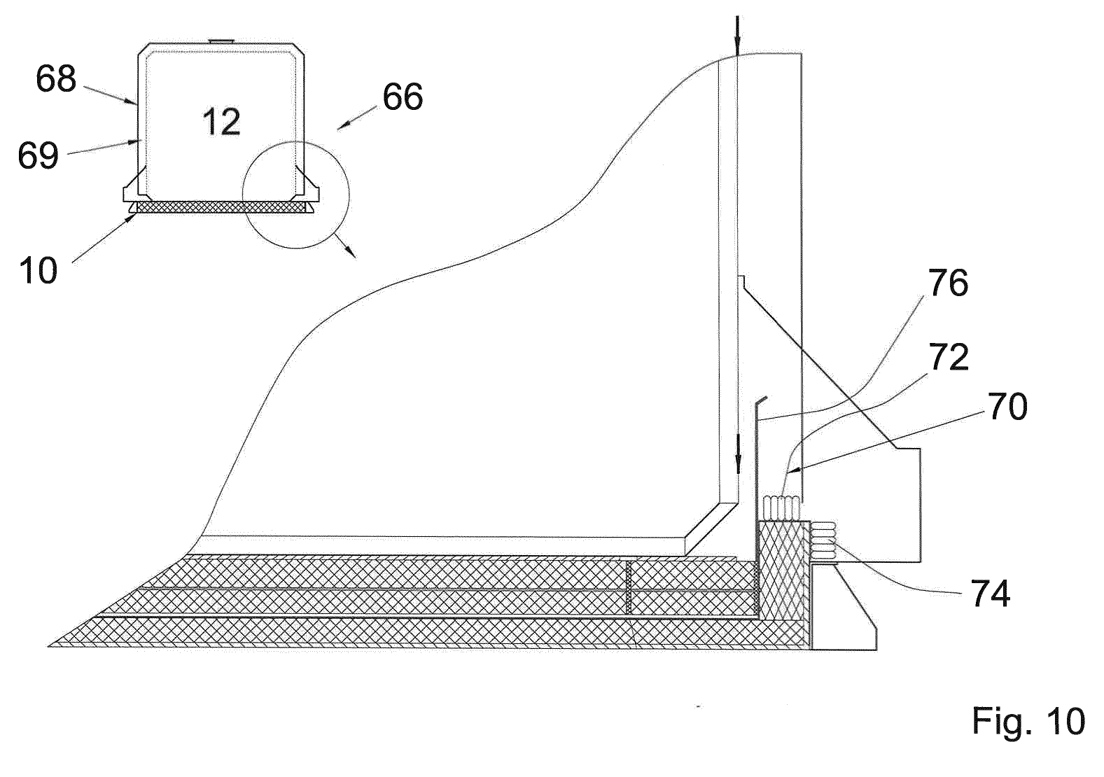

FIG. 10 illustrates a containment assembly 66 for a self-containing cryogenic tank 12. The containment assembly 66 comprises a support assembly 10 and a tank cover 68. Purely by way of example, containment assembly 66 may comprise a support assembly 10 according to any one of the above discussed embodiments.

Purely by way of example, the containment assembly 66 may be self-containing. As such, the containment assembly 66 does not necessarily have to be integrated in the structure in which it is adapted to be located. As a non-limiting example, the containment assembly 66 may be adapted to be moved in relation to the structure in which it is adapted to be located, for instance by a lifting assembly such as a crane (not shown) or the like.

The tank cover 68 is adapted to be connected to the support assembly 10 to thereby define a closed volume 69 adapted to accommodate the cryogenic tank 12. Preferably, the tank cover 68 is thermally insulating. Purely by way of example, the tank cover 68 may comprise panels of a thermally insulating material. As a non-limiting example, the thermally insulating material may be glass fibre reinforced polyurethane and/or polystyrene foam.

The containment assembly 66 may preferably comprise sealing means 70 adapted to provide a seal between the support assembly 10 and the tank cover 68. In the FIG. 9 implementation, the sealing means 70 comprises a first sealing member 72 and a second sealing member 74. Each one of the first and second sealing members 72, 74 may for instance be an elastomer seal member. Moreover, the sealing means 70 may preferably further comprise a leak shield panel 76. Purely by way of example, at least a portion of the leak shield panel 76 may extend in a direction that is substantially parallel to the rim portion 30 of the frame 26. Purely by way of example, the leak shield panel 76 is made of a SUS material. The leak shied 76 may preferably be arranged so as to guide fluid, that has leaked from the tank 12 to the closed volume 69, towards the drip tray 18.

FIG. 11 further illustrates that the containment assembly 66 may preferably comprise a tank leakage test assembly 78 adapted to detect a leakage from the tank 12. Purely by way of example, the tank leakage test assembly 78 may comprise a temperature sensor 80 located within or in contact with the drip tray 18. As another non-limiting example, the tank leakage test assembly 78 may comprise a gas detector 82. Purely by way of example, the gas detector may be in fluid communication with the leak drain conduit assembly 34 that has been discussed hereinabove with reference to FIG. 2A.

Furthermore, the containment assembly 66 may comprise a gas source 84 in fluid communication with the closed volume 69 of the containment assembly 66. Purely by way of example, the gas source 84 may be used for purging a fluid, such a nitrogen, and possibly also trace substances into the closed volume 69. The fluid leaving the closed volume 69, for instance through the leak drain conduit assembly, may be analyzed in order to evaluate e.g. the function of the second thermally insulating layer 20.

A tank assembly 86 may preferably comprise a self-containing cryogenic tank 12 and a support assembly 10 of the present invention. As a non-limiting example, a tank assembly may comprise a self-containing cryogenic tank 12 and a containment assembly 66.

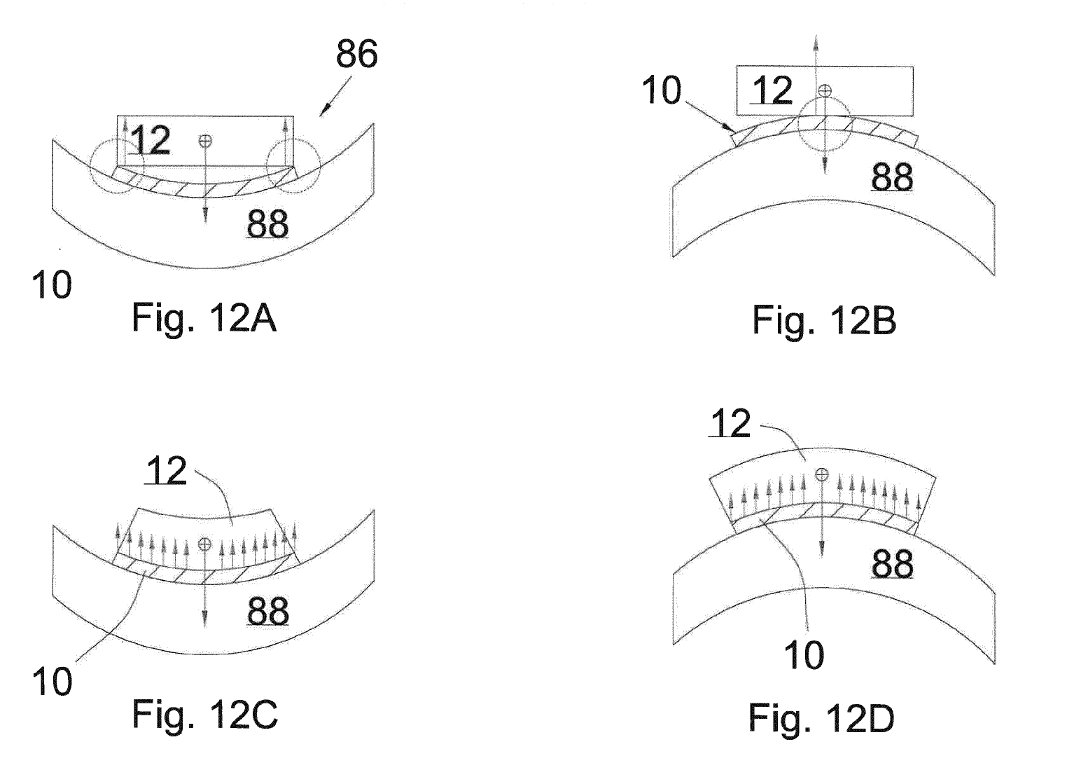

As such, FIG. 12 illustrates a vessel 88 comprising a tank assembly 86 which in turn comprises a self-containing cryogenic tank 12 and a support assembly 10. The vessel 88 is in FIG. 12 exemplified as a ship, but other implementations of a vessel are of course possible. Purely by way of example, the vessel may be a barge, an FPSO, a submarine, a hovercraft, a semi-submersible vessel or the like.

FIG. 12A and FIG. 12B illustrate an implementation of the self-containing cryogenic tank 12 that is substantially stiffer than the portion of the vessel 88 in which the tank 12 is located. Moreover, FIG. 12A and FIG. 12B illustrate scenarios in which the vessel 88 is deflected, e.g. due to wave loads, wherein FIG. 12A illustrates a sagging deflection and FIG. 12B illustrates a hogging deflection. Due to the fact that the tank 12 is substantially stiffer than the vessel in FIG. 12A and FIG. 12B, the tank 12 will not deflect to the same extent as the vessel. The above discussed deflection differences may in turn result in relatively large contact loads between e.g. the tank 12 and the support assembly 10.

FIG. 12C and FIG. 12D illustrate a preferred implementation of a self-containing cryogenic tank 12 when located in a vessel 88 which is deflected in a similar way as in the FIG. 12A and FIG. 12B example. The FIG. 12C and FIG. 12D implementation of the tank 12 is configured such that a deflection of the vessel portion in which the tank 12 is located results in a corresponding deflection of the cryogenic tank 12. As may be gleaned from FIG. 12C and FIG. 12D, by virtue of the fact that the tank 12 deflects to approximately the same extent as the vessel 88, the contact loads between e.g. the tank 12 and the support assembly 10 may be distributed over a relatively large portion of the support assembly 10. This in turn implies that the maximum local contact loads obtained with the FIG. 12C and FIG. 12D implementation of the tank 12 may be lower than the maximum loads obtained in the FIG. 12A and FIG. 12B implementation.

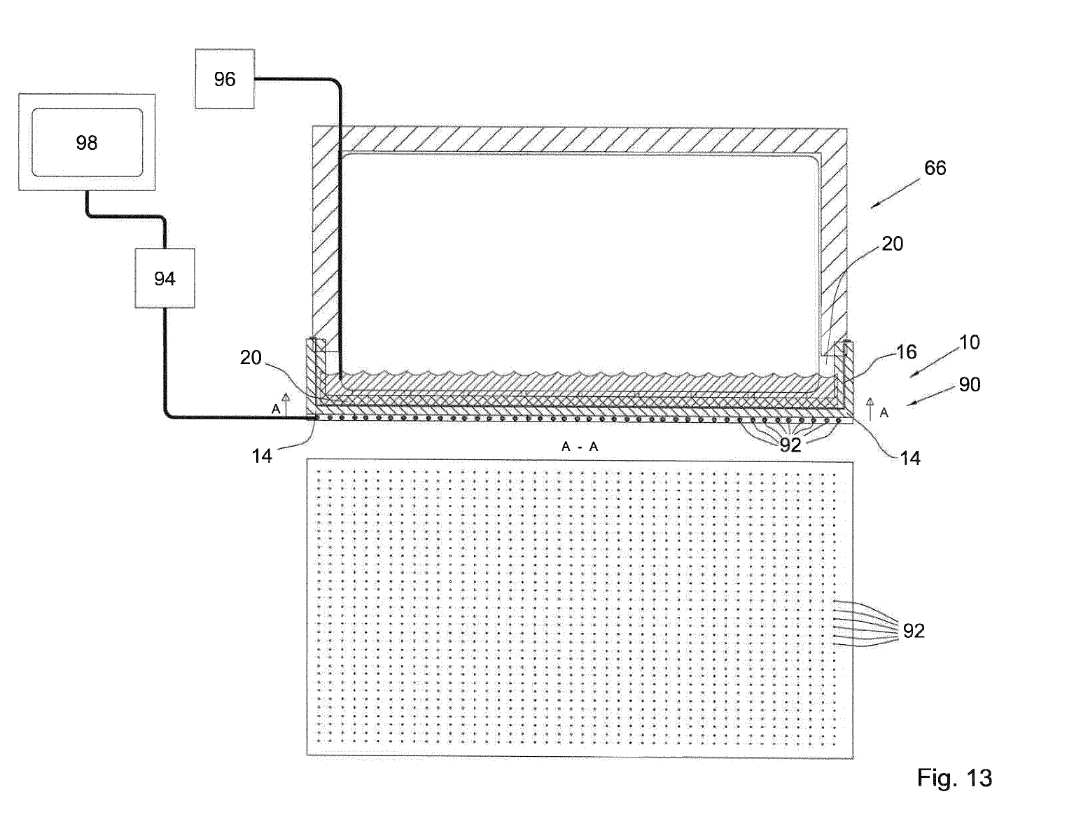

FIG. 13 illustrates that an embodiment of the support assembly 10 which comprises a tray leakage test assembly 90 comprising a temperature sensor 92 located outside the impermeable layer 16 such that at least a portion of the first thermally insulating layer 14 is located between the sensor 92 and the impermeable layer 16. FIG. 13 illustrates a preferred implementation of the tray leakage test assembly 90 which comprises a plurality of temperature sensors 92 each one of which being located outside the impermeable layer 16 such that at least a portion of the first thermally insulating layer 14 is located between the sensor 92 and the impermeable layer 16.

Preferably, a containment assembly 66 comprises the tank leakage test assembly 90 in addition to the tray leakage test assembly 78 that have been discussed in conjunction with FIG. 11 hereinabove.

In the implementation of the tray leakage test assembly 90 illustrated in FIG. 13, each one of the temperature sensors 92 is located beneath the first thermally insulating layer 14. However, in other implementations of the tray leakage test assembly 90, at least some of the temperature sensors 92 may be located in the first thermally insulating layer 14, e.g. below the impermeable layer 16 or at a horizontal distance from the impermeable layer 16. FIG. 13 further illustrates that the temperature sensors 92 may preferably be arranged so as to form a grid structure. The embodiment of the support assembly illustrated in FIG. 13 further comprises a second thermally insulating layer 20 located above the impermeable layer 16. However, the second thermally insulating layer 20 is generally not required in order to be able to perform a tray leakage test. As such, the drip tray tightness evaluation method that will be discussed below may also be performed for support assemblies that do not have a second thermally insulating layer 20.

The tray leakage test assembly 90 may preferably further comprise an electronic control unit 94 adapted to receive values indicative of the temperature in the vicinity of each one of the temperature sensors 92. Purely by way of example, a value indicative of a temperature may relate to at least one of the following entities: an actual temperature, a temperature change or a temperature change rate. Naturally, a value indicative of a temperature may comprise any combination of the above three entities.

Preferably, the tray leakage test assembly 90 further comprises a tray leakage test fluid source 96. Purely by way of example, the tray leakage test fluid source 96 may comprise a tank. The tray leakage test fluid source 96 may preferably be different from the above discussed gas source 84 that could possibly form a part of the above discussed tank leakage test assembly 78. Moreover, the tray leakage test fluid source 96 is preferably not the self-containing cryogenic tank 12 as such. Preferably, the tray leakage test fluid source 96 is separate from the self-containing cryogenic tank 12. The tray leakage test fluid source 96 may for instance be permanently installed in the support assembly 10. Optionally, the tray leakage test fluid source 96 is a separate and mobile unit that is also arranged by the support assembly 10 when the method for evaluating the tightness of a drip tray, as will be presented hereinbelow, is about to be carried out.

What is presented below is a method for evaluating the tightness of a drip tray 18 of a support assembly 10 for a self-containing cryogenic tank 12. In order to be able to perform the test method, the support assembly 10 preferably comprises a first thermally insulating layer 14 and an impermeable layer 16 located at least partially above the first thermally insulating layer 14. Moreover, the support assembly 10 comprises a plurality of temperature sensors 92 each one of which being located outside the impermeable layer 16 such that at least a portion of the first thermally insulating layer 14 is located between the sensor 92 and the impermeable layer 16. Moreover, the impermeable layer 16 at least partially forms the drip tray 18.

The method comprises introducing a fluid into the drip tray 18. The fluid may preferably be supplied from the tray leakage test fluid source 96. The fluid thus introduced has a temperature that is different from the temperature of the environment ambient of the support assembly. Purely by way of example, the fluid has a temperature that is above the temperature of the ambient environment.

However, in a preferred implementation of the test method, the fluid has a temperature that is lower than the temperature of the ambient environment. As a non-limiting example, the introduced fluid may be liquid nitrogen.

The drip tray method tightness evaluation method further comprises determining a value indicative of the temperature in the vicinity of each one of the temperature sensors. The value indicative of the temperature may for instance be one, or a combination of at least two, of the following entities: an actual temperature, a temperature change or a temperature change rate.

If no leakage occurs in the drip tray 18, the fluid introduced into the drip tray 18 will remain therein. Since the impermeable layer 16 does not generally have a large thermally insulating capability, the temperature of the impermeable layer 16 will assume a temperature that is relatively close to the temperature of the fluid. As such, if the temperature sensors 92 were to be placed in contact with the impermeable layer 16, the sensors 92 would most probably provide a temperature result in a more or less direct response to the temperature of the fluid.

However, according to the drip tray method tightness evaluation method of the present invention, each one of temperature sensors 92 is located outside the impermeable layer 16 such that at least a portion of the first thermally insulating layer 14 is located between the sensor 92 and the impermeable layer 16. As such, in the above discussed scenario where no leakage occurs, the temperature sensors 92 may detect a temperature that is different from the temperature of the fluid. Alternatively, the temperature sensors 92 may provide information indicative of that a relatively small temperature change has occurred. As another option, the temperature sensors 92 may provide information as regards a relatively low temperature change rate.

The magnitude of the either one of the above discussed temperature indication entities may for instance depend on at least one of the following: the initial temperature difference between the fluid and the ambient environment, the thermal insulation capacity of the first thermally insulating layer 14 and the amount of fluid introduced into the tray 18.

Any one of the above entities may preferably be predetermined, for instance by performing one or more test procedures for a non-leaking tray or by performing a heat conduction analysis.

Should there be one or more leakages in the drip tray 18, the fluid could pass therethrough to the first thermally insulating layer 14 during a test procedure. In such a scenario, the temperature sensor or sensors 92 located close to the leakage could then detect a temperature that is relatively close to the temperature of the fluid. Alternatively, the temperature sensors 92 may provide information indicative of that a relatively large temperature change has occurred at the temperature sensors 92 close to the leakage. As another option, the temperature sensors 92 may provide information as regards a relatively large temperature change rate at the temperature sensors 92 close to the leakage.

Any one of the above entities may also preferably be predetermined, for instance by performing one or more test procedures for a non-leaking tray or by performing a heat conduction analysis.

Three embodiments of the above discussed drip tray method tightness evaluation method will be presented hereinbelow.

In the first embodiment of the drip tray method tightness evaluation method, the value indicative of the temperature comprises a temperature in the vicinity of each one of the temperature sensors 92. The method comprises that the temperature determined at each temperature sensor 92 may be compared to a predetermined temperature range in order to determine whether or not the tightness of the drip tray 18 is impaired. As has been intimated hereinabove the end points of the predetermined temperature range may be established by means of test procedures and/or theoretical analyses.

The first embodiment of the drip tray method tightness evaluation method may also comprise that the above discussed comparison between the temperature determined at each temperature sensor 92 and the predetermined temperature range may be performed when a specific amount of time has elapsed from the time instant when the fluid was introduced into the drip tray 18. Such a predetermined temperature range may be an open or closed range. As such, if the fluid has a lower temperature than the ambient environment, the predetermined temperature range may include any temperature that is equal to or lower a predetermined threshold temperature.

As a non-limiting example, the first embodiment of the drip tray method tightness evaluation method may comprise that the temperature at each one of the temperature sensor 92 is determined when e.g. two minutes have elapsed from the time instant at which the fluid was introduced into the drip tray 18. If any one of the temperature sensor 92 then indicates a temperature that is within a specific temperature range (e.g. lower than 20° C. above the temperature of the fluid), this may be an indication that the drip tray 18 has a leakage.

In the second embodiment of the drip tray method tightness evaluation method, the value indicative of the temperature comprises a temperature change rate in the vicinity of each one of the temperature sensors 92. The method comprises that the temperature determined at each temperature sensor 92 may be compared to a predetermined temperature change rate range in order to determine whether or not the tightness of the drip tray 18 is impaired. As has been intimated hereinabove the end points of the predetermined temperature change range may be established by means of test procedures and/or theoretical analyses.

In the third embodiment of the drip tray method tightness evaluation method, the value indicative of the temperature in the vicinity of each one of the temperature sensors 92 is not necessarily compared to a predetermined range. Instead, in the third embodiment of the drip tray method tightness evaluation method may comprise that the values indicative of the temperature at each individual sensor are compared to one another in order to evaluate whether or not there is a large relative difference in the values. A large relative value difference may be indicative of a leakage. In a non-limiting example wherein the temperature as such is used as the above discussed value, the third embodiment may comprise that the temperatures in the vicinity of each one of the temperature sensors 92 are compared to one another. If a large temperature difference is detected between two temperature sensors 92, this may be an indication of a drip tray leakage. Purely by way of example, a temperature difference exceeding a predetermined difference threshold may be a value indicative of a large temperature difference between two temperature sensors 92.

It is also envisaged that further embodiments of the drip tray method tightness evaluation method may be obtained by combining two or three of the above discussed embodiments.

Furthermore, another non-limiting example of a value indicative of the temperature comprises a temperature change acceleration (i.e. a time derivative of the temperature change rate) at each one of the temperature sensors 92. The temperature change acceleration may be used instead of, or in addition to, at least one of the above discussed values indicative of the temperature.

Irrespective of which parameters that are used for the drip tray method tightness evaluation method, the method may preferably also comprise a step of indicating the position of the possible leakage. As a non-limiting example, the method may comprise a step of determining which one(s) of the temperature sensors that presents a value indicative of a leakage.

As a non-limiting example, the tray leakage test assembly 90 may preferably comprise a display 98, connected to the electronic control unit 94, which is adapted to present an illustration representative of the position of the temperature sensors. Purely by way of example, if the temperature sensors 92 are arranged so as to form a grid structure such as the one illustrated in FIG. 13, the display may be adapted to present an illustration representative of the grid structure.

The drip tray method tightness evaluation method may further comprise that a signal is issued to the display 98, for instance from the electronic control unit 94, which signal comprises information as regards which sensor(s) that has determined a value indicative of a leakage. The display 98 may then highlight the leakage indicative sensors in the sensor grid, for instance by presenting such sensors in another colour as compared to the other sensors and/or to provide additional visual information close to such sensors.

Purely by way of example, the temperature change rate may be the maximum temperature change rate that occurred during a specific time range after the fluid has been introduced into the drip tray 18. As another alternative, the temperature change rate may be an average temperature change rate that occurred during a specific time range after the fluid has been introduced into the drip tray 18.

Instead of, or in addition to the drip tray method tightness evaluation method that has been discussed hereinabove, the tightness of the drip tray 18 may be evaluated by applying a negative pressure to an enclosed volume of the support assembly 10 in which the first thermally insulating layer 14 is located and evaluating the resulting negative pressure in the enclosed volume. As a non-limiting example, the negative pressure may be applied during a desired time interval on a regular or required basis. As another non-limiting example, the negative pressure may be applied constantly.

Finally, it should be recognized that structures and/or elements and/or method steps shown and/or described in connection with any disclosed form or embodiment of the invention may be incorporated in any other disclosed or described or suggested form or embodiment as a general matter of design choice. For instance, although embodiments of the present invention have been presented in relation to a vessel, such as a ship, hereinabove, it is envisaged that embodiments of the present invention also and/or instead could be used in and/or with land based structures. It is the intention, therefore, to be limited only as indicated by the scope of the claims appended hereto.

1. A support assembly for a self-containing cryogenic tank, the support assembly comprising a first thermally insulating layer and an impermeable layer located at least partially above the first thermally insulating layer, the impermeable layer being adapted to form a drip tray for said cryogenic tank, wherein the support assembly further comprises a second thermally insulating layer located at least partially above the impermeable layer, the second thermally insulating layer being adapted to support the cryogenic tank.

2. The support assembly according to claim 1, wherein the second thermally insulating layer is adapted to support at least 50% of the weight of the cryogenic tank.

3. The support assembly according to claim 1, wherein the drip tray is sized and configured such that, when the support assembly supports the cryogenic tank, a vertical projection of the circumference of a bottom of the self-containing cryogenic tank down to said drip tray is accommodated within the circumference of the drip tray.

4. The support assembly according to claim 1, wherein at least one of the first thermally insulating layer and the second thermally insulating layer comprises a plurality of thermally insulating panels that are arranged side-by-side.

5. The support assembly according to claim 4, wherein the support assembly further comprises spacer means adapted to provide a space between at least two of the thermally insulating panels.

6. The support assembly according to claim 5, wherein the spacer means comprises a wood panel.

7. The support assembly according to claim 4, wherein at least one of the thermally insulating panels comprises a glass fibre reinforced polyurethane foam.

8. The support assembly according to claim 1, wherein the impermeable layer comprises a SUS membrane.

9. The support assembly according to claim 1, wherein the support assembly further comprises a frame, adapted to at least partially accommodate the first thermally insulating layer, the second thermally insulating layer and the impermeable layer.

10. The support assembly according to claim 1, wherein the support assembly further comprises load distributing means, adapted to be located between the second thermally insulating layer and the cryogenic tank.

11. The support assembly according to claim 1, wherein the load distributing means comprises at least one metal panel.

12. The support assembly according to claim 1, wherein the support assembly further comprises a leak drain conduit assembly at least partially extending through the impermeable layer.

13. The support assembly according to claim 1, wherein the support assembly further comprises a tray leakage test assembly comprising a temperature sensor located outside the impermeable layer such that at least a portion of the first thermally insulating layer is located between the sensor and the impermeable layer.

14. The support assembly according to claim 1, wherein the support assembly further comprises an attachment means being adapted to be engaged with a portion of the cryogenic tank to thereby limit a displacement of the cryogenic tank, relative to the support assembly, in at least one direction.

15. The support assembly according to claim 14, wherein the attachment means comprises a cavity adapted to receive a tank protrusion of the cryogenic tank.

16. The support assembly according to claim 15, wherein the attachment means is configured such that when it receives the tank protrusion, a gap (ΔH, ΔV) is formed, in at least one direction of a vertical and horizontal direction, between the tank protrusion and the attachment means.

17. The support assembly according to claim 14, wherein the support assembly comprises a foundation for the attachment means, said foundation comprising a first foundation portion, located beneath the impermeable layer, and a second foundation portion, located above the impermeable layer.

18. The support assembly according to claim 17, wherein the foundation is located at least partially within the circumference of the drip tray.

19. The support assembly according to claim 17, wherein the first foundation portion is attached to said second foundation portion via the impermeable layer.

20. The support assembly according to claim 19, wherein the first foundation portion is attached to the frame.

21. The support assembly according to claim 17, wherein at least one of the first foundation portion and the second foundation portion is made of wood.

22. A containment assembly for a self-containing cryogenic tank, the containment assembly comprising a support assembly according to claim 1 and a tank cover, the tank cover being adapted to be connected to the support assembly to thereby define a closed volume adapted to accommodate the cryogenic tank.

23. The containment assembly according to claim 22, wherein the assembly further comprises sealing means adapted to provide a seal between the support assembly and the tank cover.

24. The containment assembly according to claim 22, wherein the containment assembly further comprises a tank leakage test assembly adapted to detect a leakage from the tank.

25. The containment assembly according to claim 24, wherein the tank leakage test assembly comprises a gas detector.

26. The containment assembly according to claim 24, wherein the containment assembly comprises the tank leakage test assembly in addition to the tray leakage test assembly.

27. A tank assembly comprising a cryogenic tank and a support assembly according to claim 1.

28. A vessel comprising a support assembly according to claim 1.

29. The vessel according to claim 28, wherein the cryogenic tank is located in a vessel portion of the vessel, the cryogenic tank being configured such that a deflection of the vessel portion results in a corresponding deflection of the cryogenic tank.

30. A method for evaluating the tightness of a drip tray of a support assembly for a self-containing cryogenic tank, the support assembly comprising a first thermally insulating layer and an impermeable layer located at least partially above said first thermally insulating layer, the support assembly comprising a temperature sensor located outside the impermeable layer such that at least a portion of the first thermally insulating layer is located between the sensor and the impermeable layer, the impermeable layer at least partially forming the drip tray, the method comprising:
introducing a fluid into the drip tray, the fluid having a temperature that is different from the temperature of the environment ambient of the support assembly; and
determining a value indicative of the temperature in the vicinity of the temperature sensor.

31. The method according to claim 30, wherein the support assembly comprises a plurality of temperature sensor each one of which being located outside said impermeable layer such that at least a portion of the first thermally insulating layer is located between the sensor and the impermeable layer, the method further comprising:
determining a value indicative of the temperature in the vicinity of each one of the temperature sensors.

32. The method according to claim 30, wherein the fluid is introduced from a fluid source that is separate from the cryogenic tank.

33. The method according to claim 30, wherein the fluid has a temperature which is lower than the temperature of the ambient environment, and the fluid is liquid nitrogen.

34. The method according to claim 30, wherein the value indicative of the temperature comprises a temperature in the vicinity of said temperature sensor, the method further comprising:
comparing the temperature to a predetermined temperature range in order to determine whether or not the tightness of the drip tray is impaired.

35. The method according to claim 30, wherein the value indicative of the temperature comprises a temperature change rate in the vicinity of the temperature sensor.

36. The method according to claim 35, method further comprising:
comparing the temperature change rate to a predetermined temperature change rate range in order to determine whether or not the tightness of the drip tray is impaired.
